(19) United States
(12) Patent Application Publication
(10) Pub. No.: US 2022/0248607 A1
(43) Pub. Date: Aug. 11, 2022

(54) CONTAINMENT PANEL LINER FOR A FARM COMBINE

(71) Applicant: Raymond L. Bok, Sherwood, OH (US)

(72) Inventor: Raymond L. Bok, Sherwood, OH (US)

(21) Appl. No.: 17/591,649

(22) Filed: Feb. 3, 2022

Related U.S. Application Data
(60) Provisional application No. 63/146,750, filed on Feb. 8, 2021.

(51) Int. Cl. A01F 12/10; A01F 12/44; A01F 12/60

(52) U.S. Cl. CPC A01F 12/10; A01F 12/60; A01F 12/446

(57) ABSTRACT

A containment panel liner for use with a containment panel of a threshing assembly of a farm combine is provided. The containment panel liner includes an inner surface and an outer surface opposing the inner surface. A first major edge connects the inner and outer surfaces. A second major edge opposes the first major edge and connects the inner and outer surfaces. A first minor edge connects the first major edge to the second major edge and connects the inner and outer surfaces. A second minor edge opposes the first minor edge and connects the first major edge to the second major edge and connects the inner and outer surfaces. Taken together, the inner and outer surfaces form an arcuate cross-sectional shape that approximates an arcuate cross-sectional shape of a containment panel.

### RELATED APPLICATIONS

This application claims the benefit of pending U.S. Provisional Patent Application No. 63/146,750, filed Feb. 8, 2021, the disclosure of which is incorporated herein by reference in its entirety.

### BACKGROUND

A combine is a mobile farm machine that cuts agricultural crops from a field. As the combine cuts the crops, the combine threshes the crop cuttings, thereby separating grain from chaff and straw as the combine moves through the field. A typical combine includes a header that initially cuts the crops, which are subsequently moved up a feeder to a transition cone and into a threshing assembly. At the threshing assembly, the crop cuttings are threshed and separated from chaff and straw. The chaff and straw are released out the back of the combine and put back onto the field. The separated grain is moved through a cleaning system and put into a grain tank, to be unloaded into one or more vehicles and hauled away.

The threshing assembly of a combine can include a containment panel that is located proximate to a rotor assembly. The containment panel is configured to enclose a top portion of the rotor assembly, thereby maintaining the proximity of the crop cuttings to the rotor assembly. In many instances, as the crop cuttings are engaged by the rotor assembly, an interior surface of the containment panel is subjected to wear as the crop cuttings move across the rotor assembly.

It would be advantageous if containment panels could be improved to make them more resistant to wear.

### SUMMARY

It should be appreciated that this Summary is provided to introduce a selection of concepts in a simplified form, the concepts being further described below in the Detailed Description. This Summary is not intended to identify key features or essential features of this disclosure, nor it is intended to limit the scope of the containment panel liner for a farm combine.

The above objects as well as other objects not specifically enumerated are achieved by a containment panel liner for use with a containment panel of a threshing assembly of a farm combine. The containment panel liner includes an inner surface and an outer surface opposing the inner surface. A first major edge connects the inner and outer surfaces. A second major edge opposes the first major edge and connects the inner and outer surfaces. A first minor edge connects the first major edge to the second major edge and connects the inner and outer surfaces. A second minor edge opposes the first minor edge and connects the first major edge to the second major edge and connects the inner and outer surfaces. Taken together, the inner and outer surfaces form an arcuate cross-sectional shape that approximates an arcuate cross-sectional shape of a containment panel.

The above objects as well as other objects not specifically enumerated are also achieved by a method of using a containment panel liner within a threshing assembly of a farm combine. The method including the steps of removing existing containment panel vanes from an inner surface of a containment panel, attaching a containment panel liner to an inner surface of a containment panel, the containment panel liner having an inner surface, an outer surface opposing the inner surface, a first major edge connecting the inner and outer surfaces, a second major edge opposing the first major edge and connecting the inner and outer surfaces, a first minor edge connecting the first major edge to the second major edge and connecting the inner and outer surfaces and a second minor edge opposing the first minor edge and connecting the first major edge to the second major edge and connecting the inner and outer surfaces, wherein taken together, the inner and outer surfaces form an arcuate cross-sectional shape that approximates an arcuate cross-sectional shape of a containment panel and reattaching the removed containment panel vanes to the inner surface of the containment panel liner.

The above objects as well as other objects not specifically enumerated are also achieved by an improved threshing assembly for a farm combine. The improved threshing assembly includes a rotor assembly configured to separate grain from crop cuttings and an auger connected for a first portion of the rotor assembly and configured to advance grain crop cuttings to the rotor assembly. A transition cone is configured to enclose a portion of the auger. A containment panel is located proximate the rotor assembly and has a containment panel liner. The containment panel liner having an inner surface, an outer surface opposing the inner surface, a first major edge connecting the inner and outer surfaces, a second major edge opposing the first major edge and connecting the inner and outer surfaces, a first minor edge connecting the first major edge to the second major edge and connecting the inner and outer surfaces and a second minor edge opposing the first minor edge and connecting the first major edge to the second major edge and connecting the inner and outer surfaces, wherein taken together, the inner and outer surfaces form an arcuate cross-sectional shape that approximates an arcuate cross-sectional shape of a containment panel.

The above objects as well as other objects not specifically enumerated are also achieved by a method of using an improved threshing assembly of a farm combine. The method includes the steps of installing a containment panel liner over a first portion of a containment panel, the containment panel liner configured to protect damaged portions of the containment panel and further configured to absorb abrasive forces caused by moving crop cuttings. The containment panel liner having an inner surface, an outer surface opposing the inner surface, a first major edge connecting the inner and outer surfaces, a second major edge opposing the first major edge and connecting the inner and outer surfaces, a first minor edge connecting the first major edge to the second major edge and connecting the inner and outer surfaces and a second minor edge opposing the first minor edge and connecting the first major edge to the second major edge and connecting the inner and outer surfaces. Taken together, the inner and outer surfaces form an arcuate cross-sectional shape that approximates an arcuate cross-sectional shape of a containment panel. A plurality of containment panel vanes are attached to an interior surface of the containment panel liner. Crop cuttings are directed over the interior surface of the containment panel liner and to a rotor assembly, and the crop cuttings are impacted with projections arising from the rotor assembly in a manner such as to separate grain from the crop cuttings.

Various objects and advantages of the containment panel liner for a farm combine will become apparent to those skilled in the art from the following Detailed Description, when read in light of the accompanying drawings.

### BRIEF DESCRIPTION OF THE DRAWINGS

FIG. 1 is a perspective side view of a schematical illustration of a conventional farm combine.

FIG. 2 is an exploded perspective view, of a conventional threshing assembly of the farm combine of FIG. 1.

FIG. 3 is a front perspective view of a conventional containment panel of the threshing assembly of FIG. 2.

FIG. 4 is a front perspective view of a portion of the conventional containment panel of FIG. 3.

FIG. 5 is an exploded perspective view of an improved containment panel containing a containment panel liner in accordance with the invention.

FIG. 6 is a perspective view of the containment panel liner of FIG. 5, shown in an assembled arrangement with a containment panel.

FIG. 7 is a perspective view of the containment panel liner of FIG. 5, shown in an assembled arrangement with a containment panel and a plurality of containment panel vanes installed over the containment panel liner.

### DETAILED DESCRIPTION OF THE INVENTION

The containment panel liner for a farm combine will now be described with occasional reference to specific embodiments. The containment panel liner for a farm combine may, however, be embodied in different forms and should not be construed as limited to the embodiments set forth herein. Rather, these embodiments are provided so that this disclosure will be thorough and complete, and will fully convey the scope of the containment panel liner for a farm combine to those skilled in the art.

Unless otherwise defined, all technical and scientific terms used herein have the same meaning as commonly understood by one of ordinary skill in the art to which the containment panel liner for a farm combine belongs. The terminology used in the description of the containment panel liner for a farm combine is for describing particular embodiments only and is not intended to be limiting of the containment panel liner for a farm combine. As used in the description of the containment panel liner for a farm combine and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the containment panel liner for a farm combine. Notwithstanding that the numerical ranges and parameters setting forth the broad scope of the containment panel liner for a farm combine are approximations, the numerical values set forth in the specific examples are reported as precisely as possible. Any numerical values, however, inherently contain certain errors necessarily resulting from error found in their respective measurements.

The description and figures disclose a containment panel liner for use in a farm combine. Generally, the containment panel liner is attached to an inner surface of a containment panel and is configured to protect damaged portions of the containment panel and is further configured to absorb abrasive forces caused by crop cuttings moving across rotor assembly. The containment panel liner has a generally arcuate shape that approximates an arcuate shape of the containment panel. The containment panel liner seats against an inner surface of the containment panel in a manner such as to absorb the abrasive forces typically experienced by the inner surface of the containment panel. Advantageously, installation of the containment liner panel is significantly easier and less labor intensive than replacement of the containment panel.

The term “farm combine”, as used herein, is defined to mean any mechanism configured to harvest grain crops. The term “rotor assembly”, as used herein, is defined to mean any structure, device, assembly and/or mechanism configured to separate grain from chaff or straw. The term “containment panel”, as used herein, is defined to mean any structure, device, assembly and/or mechanism configured to enclose a portion of the rotor assembly and maintain the proximity of the crop cuttings to the rotor assembly.

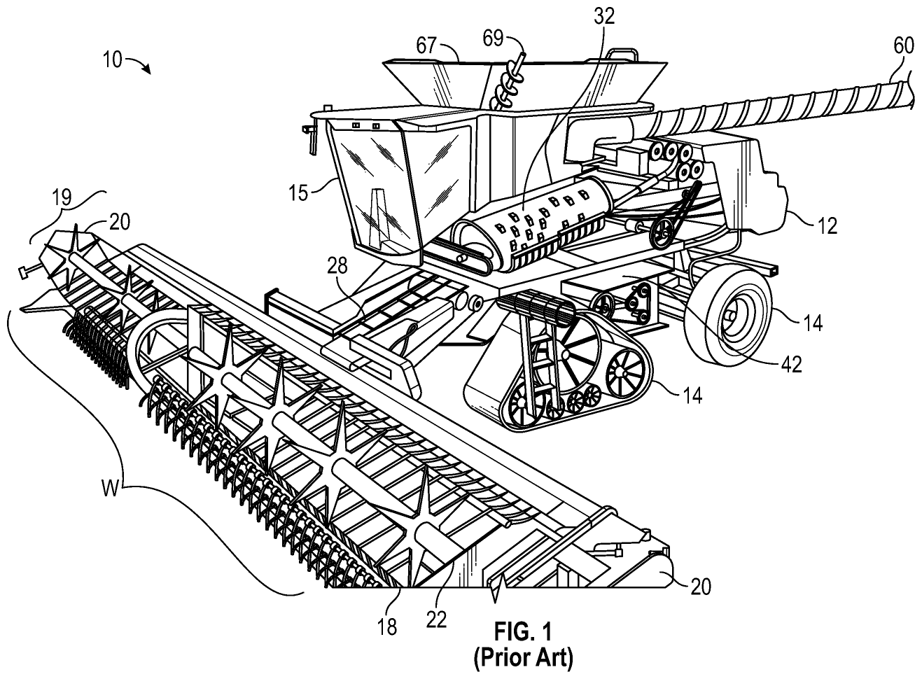

Referring now to FIG. 1, a non-limiting example of a farm combine (hereafter “combine”) is illustrated generally at 10. The combine 10 is conventional in the art and will only be briefly described herein. The combine 10 includes a support framework 12 equipped with ground engaging structures 14 extending from the supporting framework 12. The ground engaging structures 14 can include wheels, continuous tracks and the like. Operation of the combine 10 is controlled from an operator's cab 15, equipped with a plurality of controls (not shown for purposes of clarity). Grain crops (not shown) are gathered by a header 18, positioned at a front end 19 of the combine 10. The header 18 can include opposing crop dividers 20 positioned at either end of the header 18. As is known in the art, the crop dividers 20 are configured to force grain crops to be harvested into the header 18 while protecting the end of the header 18 from those grain crops which are not harvested.

Referring again to FIG. 1, the header 18 has a width W. As is known in the art, generally the wider the width W of the header 18, the faster and more efficiently the combine 10 can cut a grain crop field. It is also known that headers 18 having different widths W and different configurations can be used for cutting different grain crops. In certain instances, the header 18 can be hydraulically powered, thereby allowing the operator to raise, lower, and tilt the header 18 in different ways from the operator's cab 15.

Referring again to FIG. 1, the header 18 includes a slowly rotating wheel 22 (commonly referred to as a reel or pickup reel) positioned between the opposing crop dividers 20. The pickup reel 22 is configured to push the grain crops down toward a cutter bar (not shown for purposes of clarity). In certain embodiments, the pickup reel 22 has horizontal bars called bats and vertical teeth or tines configured to grip the stalks of the crops (for purposes of clarity, the horizontal bats and the vertical tines are not shown in FIG. 1). However, the pickup reel 22 can have other structures sufficient to push the grain crops down toward the cutter bar.

Referring again to FIG. 1, the cutter bar can extend across the length of the header 18 and can be positioned toward an underside of the pickup reel 22. In the illustrated embodiment, the cutter bar includes a plurality of teeth (not shown), configured to open and close repeatedly, thereby cutting the grain crops at their base. In other embodiments, other cutting structures and methods can be used.

Referring again to FIG. 1, a transport assembly 28 is positioned downstream from the header 18. The transport assembly 28 is configured to feed grain crop cuttings toward a threshing assembly 32. In the illustrated embodiment, the transport assembly 28 has the form of a conveyor. Alternatively, the transport assembly 28 can be any structure, mechanism, assembly or device sufficient to feed grain crop cuttings toward the threshing assembly 32. The threshing assembly 32 is configured to separate the desired grain from the unwanted portions of the crop cuttings (commonly referred to as the chaff).

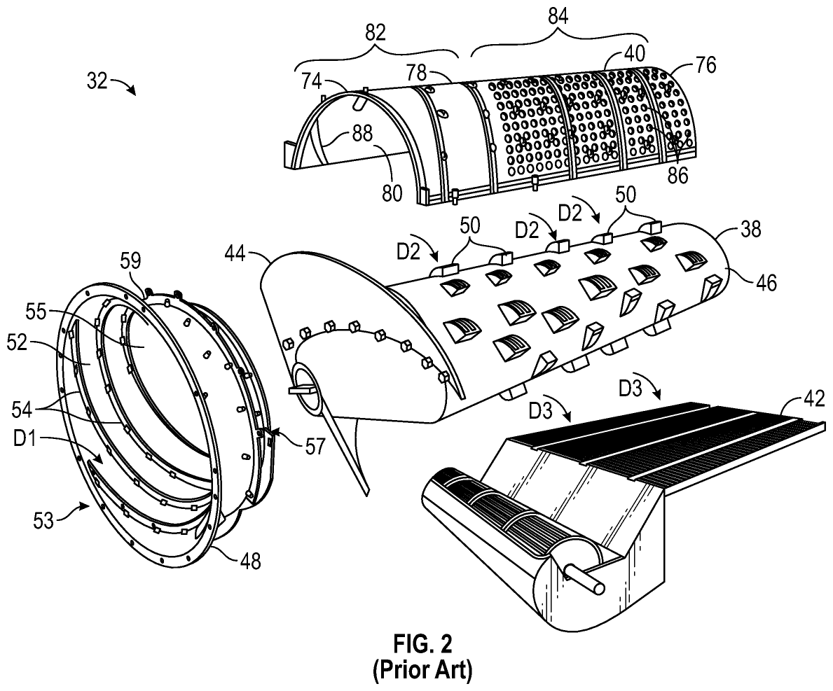

Referring now to FIG. 2, the threshing assembly 32 is shown in an exploded orientation. The threshing assembly 32 is conventional in the art and will only be briefly described herein. The threshing assembly 32 includes a rotor assembly 38 positioned between a containment panel 40 and a sieve assembly 42. The rotor assembly 38 is configured for rotation and includes an auger 44 positioned upstream from a threshing rotor segment 46. The auger 44 is positioned within a transition cone 48 and is configured to advance the grain crop cuttings to the threshing rotor segment 46. The threshing rotor segment 46 includes a plurality of outwardly extending projections 50 configured to engage the grain crop cuttings, such as to break and shake the desired grain from the undesired chaff.

Referring again to FIG. 2, in operation, the rotation of the auger 44 urges the grain crop cuttings against an inner surface 52 of the transition cone 48 as schematically illustrated by direction arrow D1. The grain crop cuttings are guided by a plurality of transition cone vanes 54, attached to the inner surface 52 of the transition cone 48, in a downstream direction toward the threshing rotor segment 46. The transition cone 48 is a funnel shaped structure configured to receive the grain crop cuttings at an outer opening 53 and convey the grain crop cuttings through an interior passage 55 extending from the outer opening 53 to an inner opening 57. The transition cone 48 is formed with a circumferential sidewall 59.

Referring again to FIG. 2 and further to the operation, the grain crop cuttings are conveyed to contact with the projections 50 on the threshing rotor segment 46 as schematically illustrated by direction arrows D2. The projections 50 engage the grain crop cuttings, thereby breaking the grain from the chaff. The grain, now substantially free from the chaff, falls through the sieve assembly 42, as schematically illustrated by direction arrow D3. The chaff is moved by one or more conveyors, in a direction toward the back of the combine 10.

Referring now to FIG. 1, the grain is conveyed to a collecting tank 67 by a conveyance assembly 69. In the illustrated embodiment, the conveyance assembly 69 is an auger-based structure. Alternatively, the conveyance assembly 69 can be any structure, mechanism, assembly or device sufficient to convey grain to the collecting tank 67.

Referring again to FIG. 1, when the collecting tank 67 is full of grain, the grain is transported from the collecting tank 67 to an outlet port 60. Upon exiting the outlet port 60, the grain can be loaded onto transportation devices, such as the non-limiting example of a tractor with one or more trailers. In certain embodiments, the grain can be transported from the collecting tank 67 to the outlet port 60 by mechanisms and structures such as an elevator and a side pipe (sometimes referred to as the unloader). However, other mechanisms and structures sufficient to transport the grain from the collecting tank 67 to the outlet port 60 can be used.

Referring again to FIG. 1 in a final operational step, chaff is conveyed to the rear of the combine 10 and dispersed from the combine 10. In certain embodiments, the combine can have a rotating spreader mechanism configured to spread the chaff over a wide area. In other embodiments, the chaff can be baled by a baling machine and used for other farm related purposes.

Referring now to FIG. 2, the containment panel 40 is spaced apart from the rotor assembly 38 and is configured to enclose a top portion of the rotor assembly 38. The containment panel 40 includes a leading end 74, an opposed trailing end 76, an exterior surface 78 and an interior surface 80. The leading end 74 is the end of the containment panel 40 adjacent to the transition cone 48. A first portion 82 of the containment panel 40 extends from the leading end 74 in a direction toward the trailing end 76. A second portion 84 extends from the first portion 82 to the trailing end 76. In the illustrated embodiment, the first portion 82 is formed of a substantially continuous material. The second portion 84 includes a plurality of apertures 86. As is known in the art, the plurality of apertures 86 have the form of slots and are configured to facilitate adjustment of a plurality of adjustable containment panel vanes 88. The containment panel 40 has an arcuate cross-section shape that generally approximates an arcuate shape of the threshing rotor segment 46 of the rotor assembly 38.

Referring again to FIG. 2, the plurality of adjustable containment panel vanes 88 are positioned on the interior surface 80 of the containment panel 40. The containment panel vanes 88 have an angular pitch that is configured to determine the amount of time the grain crop cuttings are within the threshing assembly 32. The term “angular pitch”, as used herein, is defined to mean an angle formed by a longitudinal axis of a containment panel vane 88 and a line arranged to be perpendicular to a longitudinal outer edge of the containment panel 40. In the illustrated embodiment, the adjustable containment panel vanes 88 are the same as, or similar to, the transition cone vanes 54 described above. In other embodiments, the adjustable containment panel vanes 88 can be different from the transition cone vanes 54. In operation, as the grain crop cuttings are conveyed to the projections 50 on the threshing rotor segment 46, the interior surface 80 of the first portion 82 of the containment panel 40 can incur abrasive forces caused by the moving grain crop cuttings.

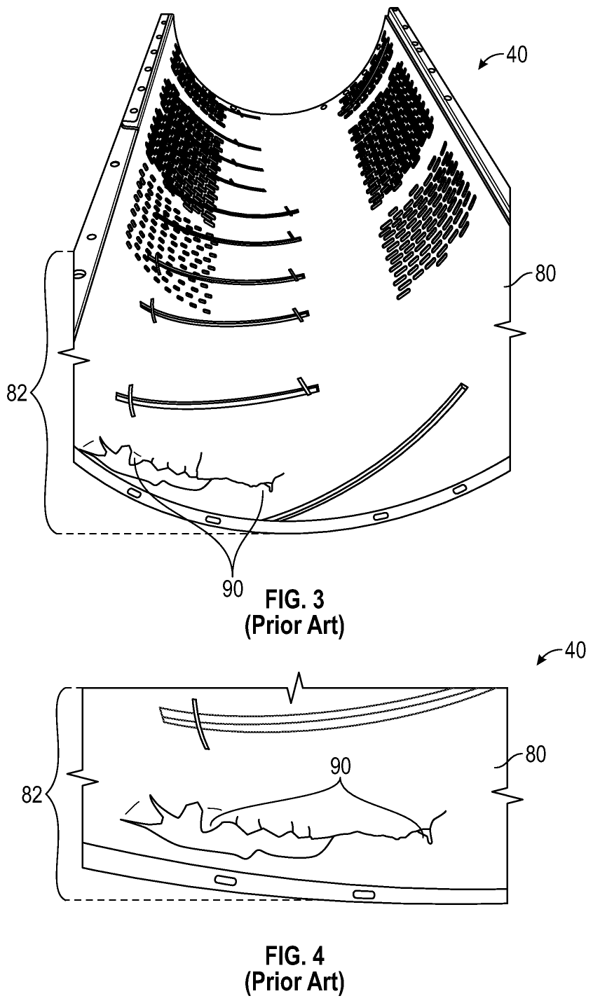

Referring now to FIGS. 3 and 4, the interior surface 80 of a used containment panel 40 is illustrated. For purposes of clarity, the adjustable containment panel vanes 88 have been removed from the interior surface 80. The term “used”, as referred to herein, is defined to mean previously installed in an operating farm combine 10 and employed in the operation of threshing crop cuttings. In certain instances, the abrasive forces can cause damage in the form of wear areas 90 to the interior surface 80 of the first portion 82 of the containment panel 40. The wear areas 90 can negatively affect the operation and performance of the combine 10.

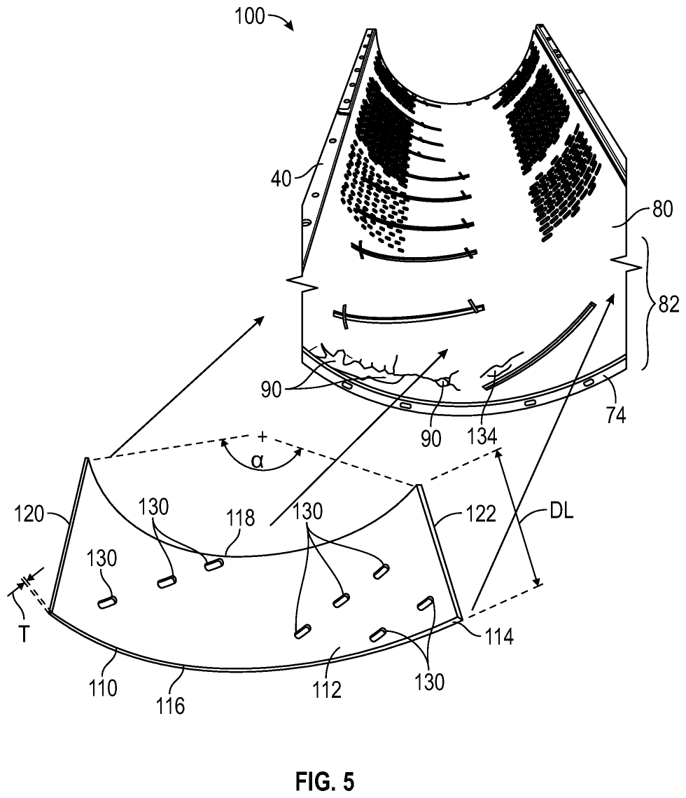

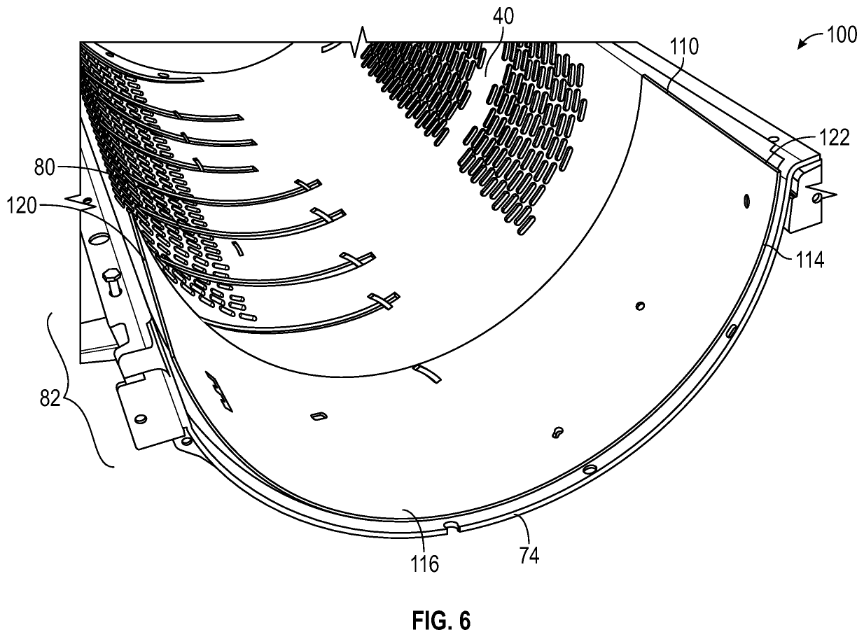

Referring now to FIGS. 5 and 6, a novel and improved containment panel assembly is shown generally at 100. The containment panel assembly 100 includes a containment panel 40 fitted with a containment panel liner 110. The containment panel liner 110 is configured for several functions. First, the containment panel liner 110 is configured to cover the wear areas 90 (FIGS. 3-5) of the interior surface 80 of the first portion 82 of the containment panel 40 in a manner such that the moving grain crop cuttings avoid engagement with the wear areas 90. Second, the containment panel liner 110 is configured to absorb the abrasive forces caused by the grain crop cuttings moving through the containment panel assembly 100. Third, the containment panel liner 110 is configured to seat against the interior surface 80 of the first portion 82 of the containment panel 40 in a manner such the flow of the moving grain crop cuttings through the containment panel assembly 100 is unimpeded. Finally, the containment panel assembly 100 is configured to guide and facilitate the movement of the crop cuttings through the containment panel assembly 100.

Referring now to FIG. 5, the containment panel liner 110 has an inner surface 112, an opposing outer surface 114, a first major edge 116, an opposing second major edge 118, a first minor edge 120 and an opposing second minor edge 122. In the embodiment illustrated in FIG. 5, the containment panel liner 110 is formed as a one-piece, unitary body. However, in other embodiments, the containment panel liner 110 can be formed from discrete elements that are joined together.

Referring now to FIGS. 5 and 6, the containment panel liner 110 has an arcuate cross-sectional shape, configured to substantially align with the arcuate shape of the interior surface 80 of the first portion 82 of the containment panel 40. The arcuate shape of the containment panel liner 110 forms an angle α. The angle α is configured to cover the internal surface 80 of the first portion 82 of the containment panel 40 ranging from the first minor edge 120 to the second minor edge 122. In the illustrated embodiment, the angle α is in a range of from about 125° to about 200°. In alternate embodiments, the angle α can be less than about 125° or more than about 200°, sufficient to cover the internal surface 80 of the first portion 82 of the containment panel 40 from the first minor edge 120 to the second minor edge 122. It is further contemplated that in other embodiments, the angle α of the containment panel liner 110 may be less than the internal surface 80 of the first portion 82 of the containment panel 40 from the first minor edge 120 to the second minor edge 122.

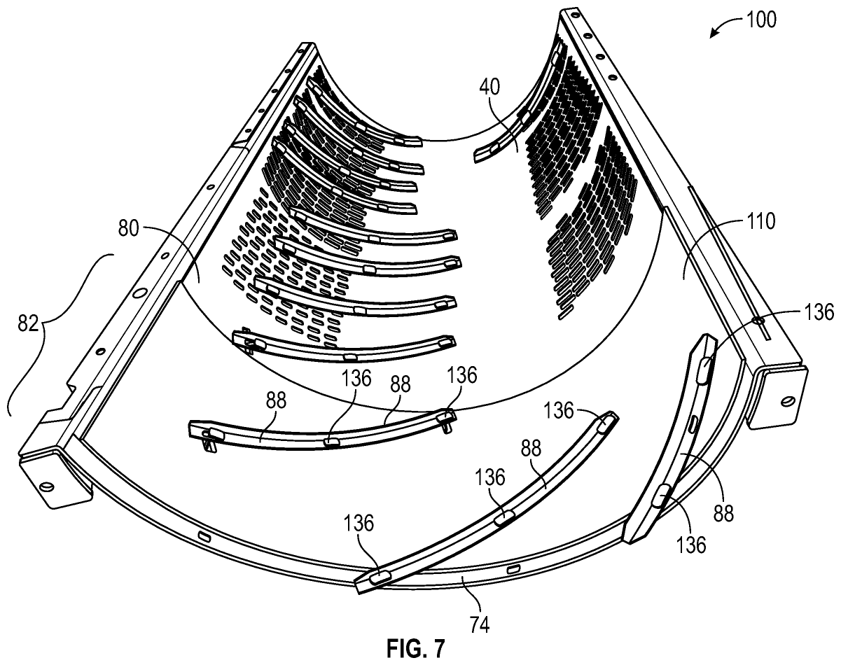

Referring again to FIG. 5, the containment panel liner 110 has a depth DL. The depth DL of the containment panel liner 110 generally corresponds to the depth of the first portion 82 of the containment panel 40. More specifically, the depth DL of the containment panel liner 110 facilitates use of full-length adjustable containment panel vanes 88 (FIG. 7). In this manner, advantageously the containment panel liner 110 allows re-use of the adjustable containment panel vanes 88 without modification of the length of the adjustable containment panel vanes 88. In the illustrated embodiment, the depth DL is in a range of from about 10.0 inches to about 30.0 inches. Alternatively, the depth DL of the containment panel liner 110 can be less than about 10.0 inches or more than about 30.0 inches, sufficient that the first portion 82 of the containment panel 40 is covered by the containment panel liner 110 and the adjustable containment panel vanes 88 can be reused without modification. It is further contemplated that in other embodiments, the depth DL of the containment panel liner 110 may be more or less than the depth of the first portion 82 of the containment panel 40.

Referring again to FIG. 5, the containment panel liner 110 has a thickness T. The thickness T of the containment panel liner 110 is configured to absorb abrasive forces caused by crop cuttings moving across the inner surface 112 of the containment panel 40. In the illustrated embodiment, the thickness T is in a range of from about 0.10 inches to about 0.2 inches. However, in other embodiments, the thickness T can be less than about 0.10 inches or more than about 0.2 inches, sufficient to absorb abrasive forces caused by crop cuttings moving across the inner surface 112 of the containment panel.

Referring again to FIG. 5, in certain instances the abrasive forces caused by crop cuttings moving across the inner surface 112 of the containment panel 40 can be severe. In those instances, the containment panel liner 110 can be formed of a material having a sufficient surface hardness to substantially absorb the severe abrasive forces and avoid frequent replacement of the containment panel liner 110. In the illustrated embodiment, the containment panel liner 110 is formed from AR500 abrasion resistant steel plate having a Brinell hardness rating of 500 HB. In other embodiments, the containment panel liner 110 can be formed from other materials or combinations of materials sufficient to absorb the severe abrasive forces and avoid frequent replacement of the containment panel liner 110.

Referring again to FIG. 5, in certain embodiments the inner surface 112 of the containment panel liner 110 can be coated with one or more friction reducing materials configured to facilitate movement of the crop cuttings across the inner surface 112 of the containment panel liner 110 and one or more abrasion resistant materials configured to provide additional abrasion resistance. Non-limiting examples of suitable friction reducing and abrasion resistant coatings include silicon-based epoxies, dense plasma-based coatings, polymeric coatings, diamond-like carbon coatings (commonly referred to as “dlc” coatings), carbide-based coatings and the like.

Referring again to FIG. 5, the containment panel liner 110 has a plurality of apertures 130 extending from the inner surface 112 to the outer surface 114. As will be discussed in more detail below, the apertures 130 are configured to align with existing apertures 134 located in the first portion 82 of the in the containment panel 40. In the illustrated embodiment, the apertures 130 are arranged in a repeating, spiral pattern. In other embodiments, the apertures 130 can be arranged in other patterns, configured to align with the existing apertures 134 in the first portion 82 of the containment panel 40.

Referring now to FIGS. 6 and 7, installation of the containment panel liner 110 will now be described. In an initial step, the adjustable containment panel vanes 88 are removed from the first portion 82 of the containment panel 40. Following removal of the vanes 88, in a next step the containment panel liner 110 is seated against the interior surface 80 of the first portion 82 of the containment panel 40, with the first major edge 116 of the containment panel liner 110 adjacent the leading end 74 of the containment panel 40 and the first and second minor edges 120, 122 of the containment panel liner 110 aligned with the opposing edges of the containment panel 40. Once properly aligned, in a next step the containment panel liner 110 is attached to the containment panel 40. In the illustrated embodiment, the container panel liner 110 is attached to the containment panel 40 by welding. However, in other embodiments, the containment panel liner 110 can be attached to the containment panel 40 by other desired methods, including the non-limiting examples of clips, clamps and other suitable structures. In the installed position, the apertures 130 of the containment panel liner 110 align with existing apertures 134 located in the first portion 82 of the containment panel 40.

Referring again to FIGS. 6 and 7 in a next step, the adjustable containment panel vanes 88 are aligned with the apertures 130 of the installed containment panel liner 110. Next, fasteners 136 are inserted through the adjustable containment panel vanes 88, through the apertures 130 and through the apertures 134 positioned in the first portion 82 of the containment panel 40. The fasteners 136 are configured to attach the adjustable containment panel vanes 88 to the containment panel liner 110 and to the containment panel 40. Advantageously, such alignment of the apertures 130, 134 facilitates reuse of the adjustable containment panel vanes 88.

Referring now to FIG. 5, the apertures 130 of the containment panel liner 110 have the form of slots. The slots advantageously facilitate adjustment of the angular pitch of the containment panel vanes 88, thereby adjusting the amount of time the grain crop cuttings are within the first portion of the threshing assembly 32

The novel containment panel liner 110 provides many benefits, although all benefits may not be available in all embodiments. First, the novel containment panel liner 110 facilitates re-use of worn or damaged containment panels. Second, the novel containment panel liner 110 absorbs the abrasive forces caused by the grain crop cuttings moving through the containment panel assembly 100. Third, the containment panel liner 110 seats against the interior surface 80 of the first portion 82 of the containment panel 40 in a manner such the flow of the moving grain crop cuttings through the containment panel assembly 100 is unimpeded. Fourth, the containment panel liner 110 facilitates re-use of the adjustable containment panel vanes without modification to the adjustable containment panel vanes.

The principle and mode of operation of the containment panel liner for a farm combine has been described in certain embodiments. However, it should be noted that the containment panel liner for a farm combine may be practiced otherwise than as specifically illustrated and described without departing from its scope.

What is claimed is:

1. A containment panel liner for use with a containment panel of a threshing assembly of a farm combine, comprising:
an inner surface;
an outer surface opposing the inner surface;
a first major edge connecting the inner and outer surfaces;
a second major edge opposing the first major edge and connecting the inner and outer surfaces;
a first minor edge connecting the first major edge to the second major edge and connecting the inner and outer surfaces; and
a second minor edge opposing the first minor edge and connecting the first major edge to the second major edge and connecting the inner and outer surfaces;
wherein taken together, the inner and outer surfaces form an arcuate cross-sectional shape that approximates an arcuate cross-sectional shape of a containment panel.

2. The containment panel liner of claim 1, wherein a plurality of apertures extend from the inner surface to the outer surface.

3. The containment panel liner of claim 2, wherein the plurality of apertures form a pattern that aligns with a pattern of apertures in the containment panel.

4. The containment panel liner of claim 3, wherein the pattern of apertures in the containment panel liner is spiral shaped.

5. The containment panel liner of claim 2, wherein each of the plurality of apertures has the form of a slot.

6. The containment panel liner of claim 1, wherein the containment panel liner is formed from AR500 abrasion resistant steel plate.

7. The containment panel liner of claim 1, wherein the inner surface has a Brinell hardness rating of 500 HB.

8. The containment panel liner of claim 1, wherein the inner surface is coated with one or more materials configured to provide additional abrasion resistance.

9. The containment panel liner of claim 1, wherein the inner surface is coated with a carbide coating.

10. A method of using a containment panel liner within a threshing assembly of a farm combine, comprising the steps of:
removing existing containment panel vanes from an inner surface of a containment panel;
attaching a containment panel liner to an inner surface of a containment panel, the containment panel liner having an inner surface, an outer surface opposing the inner surface, a first major edge connecting the inner and outer surfaces, a second major edge opposing the first major edge and connecting the inner and outer surfaces, a first minor edge connecting the first major edge to the second major edge and connecting the inner and outer surfaces and a second minor edge opposing the first minor edge and connecting the first major edge to the second major edge and connecting the inner and outer surfaces, wherein taken together, the inner and outer surfaces form an arcuate cross-sectional shape that approximates an arcuate cross-sectional shape of a containment panel; and
reattaching the removed containment panel vanes to the inner surface of the containment panel liner without modification of the length of the removed containment panel vanes.

11. The method of claim 10, including the step of seating the outer surface of the containment panel liner against an inner surface of the containment panel.

12. The method of claim 11, including the step of aligning apertures in the containment panel liner with apertures in the containment panel.

13. The method of claim 10, including the step of adjusting an angular pitch of the reattached containment panel vanes.

14. An improved threshing assembly for a farm combine, comprising:
a rotor assembly configured to separate grain from crop cuttings;
an auger connected for a first portion of the rotor assembly and configured to advance grain crop cuttings to the rotor assembly;
a transition cone configured to enclose a portion of the auger; and
a containment panel is located proximate the rotor assembly and has a containment panel liner, the containment panel liner having an inner surface, an outer surface opposing the inner surface, a first major edge connecting the inner and outer surfaces, a second major edge opposing the first major edge and connecting the inner and outer surfaces, a first minor edge connecting the first major edge to the second major edge and connecting the inner and outer surfaces and a second minor edge opposing the first minor edge and connecting the first major edge to the second major edge and connecting the inner and outer surfaces, wherein taken together, the inner and outer surfaces form an arcuate cross-sectional shape that approximates an arcuate cross-sectional shape of a containment panel.

15. The improved threshing assembly of claim 14, wherein a plurality of apertures in the containment panel liner form a pattern that aligns with a pattern of apertures in the containment panel.

16. The improved threshing assembly of claim 15, wherein adjustable containment panel vanes are connected to the plurality of apertures in the containment panel liner.

17. The improved threshing assembly of claim 16, wherein an angular pitch of the containment panel vanes is adjustable.

18. A method of using an improved threshing assembly of a farm combine, comprising the steps of:
installing a containment panel liner over a first portion of a containment panel, the containment panel liner configured to protect damaged portions of the containment panel and further configured to absorb abrasive forces caused by moving crop cuttings, the containment panel liner having an inner surface, an outer surface opposing the inner surface, a first major edge connecting the inner and outer surfaces, a second major edge opposing the first major edge and connecting the inner and outer surfaces, a first minor edge connecting the first major edge to the second major edge and connecting the inner and outer surfaces and a second minor edge opposing the first minor edge and connecting the first major edge to the second major edge and connecting the inner and outer surfaces, wherein taken together, the inner and outer surfaces form an arcuate cross-sectional shape that approximates an arcuate cross-sectional shape of a containment panel;
attaching a plurality of containment panel vanes to an interior surface of the containment panel liner;
directing crop cuttings over the interior surface of the containment panel liner and to a rotor assembly; and
impacting the crop cuttings with projections arising from the rotor assembly in a manner such as to separate grain from the crop cuttings.

19. The method of claim 18, including the step of aligning apertures in the containment panel liner with apertures in the containment panel.

20. The method of claim 18, including the step of adjusting an angular pitch of the attached containment panel vanes.
